(19) United States
(12) Patent Application Publication
(10) Pub. No.: US 2017/0172077 A1
(43) Pub. Date: Jun. 22, 2017

(54) PROPERTY LANDSCAPE MANAGEMENT APPARATUS AND METHOD

(71) Applicant: Intel Corporation, Santa Clara, CA (US)

(72) Inventors: Rita H. Wouhaybi, Portland, OR (US); Richard T. Beckwith, Hillsboro, OR (US); Kathi R. Kitner, Hillsboro, OR (US); Hong Li, El Dorado Hills, CA (US); Igor Tatourian, Fountain Hills, AZ (US); Omar U. Florez, Sunnyvale, CA (US)

(21) Appl. No.: 14/973,207

(22) Filed: Dec. 17, 2015

(51) Int. Cl. A01G 25/16; G05B 13/02

(52) U.S. Cl. CPC A01G 25/16; G05B 13/0265

(57) ABSTRACT

Embodiments of techniques, apparatuses, systems and computer-readable media for managing landscape of a property are disclosed. In some embodiments, a configuration module may be configured to receive data that specifies landscape or preferences for the landscape, and a sensor control module may configured to control operation of one or more sensors to record and report landscape associated operational data. In embodiments, a data aggregation and analysis module may be configured to receive environmental data for surroundings of the landscape and aggregate and analyze the environmental data, management preference data, and landscape data, and may cause appropriate irrigation to be provided to the landscape. Other embodiments may be disclosed and/or claimed.

### TECHNICAL FIELD

The present disclosure relates generally to the technical field of control systems, and more particularly, to landscape management and maintenance control systems.

### BACKGROUND

Water is an important and fundamental resource, and has been defined as a human right by the United Nations. As drought conditions increase, many governments are instituting laws and policies to encourage their citizens to conserve water. For example, regulators in California have recently added a series of restrictions on watering lawns, fining violators up to $500. For most consumers, it may not be clear how to meet landscape water use restrictions, or to generally be more efficient in their landscape water usage without majorly disrupting their daily routines by performing a large number of manual tasks.

In addition, water shortages are becoming a global problem. In many water management programs, water usage outdoors is considered a luxury and may be restricted, for example in Las Vegas, Australia, and Israel.

For many homeowners, summers may mean a lush green lawn and ornamental flowering annuals. Homeowner and business lawns may also include established greenery, bushes, vines and trees. In addition, in some areas, such as the west coast of the United States, there is an increase in interest in edible seasonal gardens. 2013 estimates indicate 42 million households are growing food in their yard or in a community garden.

Many of these outdoor areas, especially in established areas, may be irrigated by: (1) setting automated sprinkler systems with timed on and off cycles, or (2) relying on manual hand watering with a hose, watering can, or other labor intensive process. Sprinkler guidelines and manual practices often err on the side of overwatering; sometimes so much water is used that lawns may get saturated and nearby sidewalks may be flooded. Another example is when a homeowner is on vacation and the sprinklers are on at the same time that rain is pouring.

### BRIEF DESCRIPTION OF THE DRAWINGS

These and other issues may be overcome by implementing embodiments of this disclosure. Embodiments may enable consumers to manage and lower their landscape water consumption. In addition, embodiment implementations may provide: efficient water management in the landscape minimal human intervention; techniques for establishing new standards for watering with different weather, soil conditions, vegetation, and user preferences; and an infrastructure for sharing data and resources among parties, including certifying to utility companies and municipalities customer compliance with watering policies.

Embodiments will be readily understood by the following detailed description in conjunction with the accompanying drawings. To facilitate this description, like reference numerals may designate like structural elements. Embodiments are illustrated by way of example, and not by way of limitation, in the figures of the accompanying drawings.

FIG. 1 depicts a diagram of an example landscape that may be serviced by a landscape manager apparatus incorporated with the teachings of the present disclosure, in accordance with various embodiments.

FIG. 2 illustrates electronic device circuitry that may be circuitry for the landscape manager apparatus of claim 1, in accordance with various embodiments.

FIG. 3 illustrates modules that may reside on the memory/storage of landscape manager apparatus of FIG. 2, in accordance with various embodiments.

FIG. 4 is a flow diagram of an illustrative process for landscape management, in accordance with various embodiments.

FIG. 5 is a diagram illustrating a non-transitory computer-readable storage medium having instructions to practice the process of FIG. 4, in accordance with various embodiments.

### DETAILED DESCRIPTION

Embodiments, techniques, apparatuses, systems and computer-readable media for managing a landscape of a property are disclosed. In some embodiments, a landscape management apparatus may include a configuration module configured to receive data that specifies the landscape or preferences for the landscape, and a sensor control module configured to control operation of one or more sensors to record and report landscape associated operational data. The apparatus may further include a data aggregation and analysis module configured to receive environmental data for surroundings of the landscape, aggregate and analyze the environmental data, management preference data, and landscape data, and cause appropriate irrigation to be provided to the landscape. In embodiments, the data aggregation and analysis module may also cause chemicals to be provided to the landscape.

In the following detailed description, reference is made to the accompanying drawings which form a part hereof wherein like numerals may designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description uses the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. As used herein, the term “logic” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Over the last decade, some owners and/or property managers have attempted to move away from scheduled landscape watering to the use of sensor-activated watering modules. This has been challenging for a number of reasons. First, even the simplest of landscapes have wide variations in moisture exposure and needs due to soil, sun exposure, vegetation, foot traffic, and other factors. As a result, a large number of sensors may be needed to provide an accurate measure of water needs. Maintaining these sensors may be challenging: sensors often break due to being emerged in harsh conditions such as soil, humidity, pets, lawnmowers, foot traffic, and the like is an on-going task that homeowners and/or property managers dread. Secondly, sprinklers, drip systems, and other emitters may lack a fine grain control that may make emitter activation an on-or-off event, rather than a flow range from off to on. As a result, emitter flow rates may be set at averages for watering that may be sub-optimal to different parts of the landscape.

Further, user feedback is often not part of legacy landscape management systems, where users may be limited to the on-or-off control that an owner or property manager may have. Adjusting watering system schedules, water pressure, and water location may seem like a never ending task, particularly with season shifts, changes in the environment and the types and ages of the different plants. As a result, owners and/or property managers frequently end up over-watering because they prefer to treat legacy systems as “set it and forget it.”

In addition, as owners and/or property managers adopt a more environmentally-friendly attitude, they may be increasingly more willing, for example, to sacrifice a large, dark green lawn for less water-consuming behavior such as focusing on a small area of the yard or allowing the grass to be less green in color. It is a challenge to get legacy sprinkler and/or drip systems to adjust to variations in water balancing automatically. In addition, it may be frustrating to calibrate legacy systems only to have to recalibrate them as seasons change.

The present disclosure provides a low-maintenance landscape sensing network with environmental and imaging data to adapt water delivery based on landscape requirements. In embodiments, this adaptive system may have one or more of the following characteristics.

Sensing characteristics, where environmental sensors may be used to test water and soil conditions; imaging data may be is obtained from several sources that may include cameras, a drone, or satellite imaging; and/or environmental data that may be measured by multiple parties including the weather bureau.

Data analytics characteristics, which may be used to understand a landscape response to different watering conditions; and may be to further refine the profile of property owners and/or property managers, to at least determine their preferences in terms of landscape appearance and requirements.

Data sharing characteristics, that may include a collaborative system to map the different preferences of users and/or property managers, and to provide recommendations for water use, landscape design and general plant care. Data sharing may also enable a secure water management dashboard that may verify the amount of landscape water use of a customer to various utility companies. Data sharing may enable water consumption audits, where goals may be set by property managers or by utility companies. In another non-limiting example, data may be shared with suppliers and manufacturers of different products deployed on the landscape to confirm whether a product works as intended, or to identify other properties of the applied product.

Control characteristics, which may include actuators that may be deployed in the landscape by the system, such as an existing drip/sprinkler system. In embodiments, the system may directly control the existing drip/sprinkler system, if possible, or may provide recommendations for the consumer to provide adjustments to the drip/sprinkler system. In addition, the system may deliver other substances used by the plant, for example pesticide or fertilizers, or may perform other actions such as removal of obstructions or problem items with a drone.

Embodiments of the disclosure herein may be operated over a number of properties, for example a homeowners association or a business park. Implementation embodiments may be used as a water budgeting mechanism, or may be used as a landscape appearance enforcement tool to ensure owners are adhering to bylaws.

Implementation embodiments may also be used by water services and municipalities to ensure customers are adhering to watering restrictions, or monitoring for visible water leaks. Such implementations may save water utilities money and resources by reviewing large areas looking for leaks and other problems indicated by landscape conditions, with a minimum of human intervention. Embodiments of the disclosure may interface with one or more legacy systems.

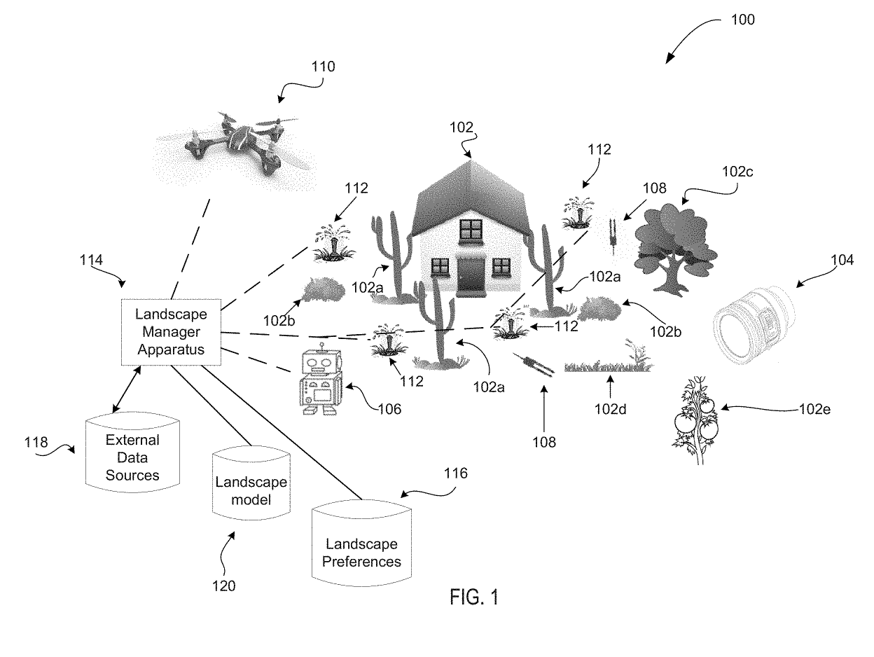

FIG. 1 depicts a diagram of an example landscape that may be serviced by a landscape manager apparatus incorporated with the teachings of the present disclosure, in accordance with various embodiments. Diagram 100 illustrates an example landscape that may include a house 102 surrounded by a landscape that may include a plurality of plants, such as cactus 102a, rosebushes 102b, trees 102c, groundcover such as grass 102d, and tomato plants 102e. In embodiments, any plants in any configuration may be used, including plants on or hanging from (not shown) the house 102.

The landscape may also include a variety of sensor devices that may include one or more cameras 104, one or more robots 106, one or more in-ground sensors 108 and/or one or more drones 110. In embodiments, these devices may be used to sense the condition of the landscape. In embodiments, the condition of the landscape may include soil conditions, such as wetness, acidity, chemical composition, density, and the like. In embodiments, the condition of the landscape may include plant conditions such as plant health, plant hydration, plant foliage conditions, whether the plant may be budding and/or blooming, pests appearing on plants, and the like. In embodiments, the condition of the landscape may include identifying types of animals that come onto the landscape, their time and/or path through the landscape, where they may stop, which plants they may interact with, and the like.

In embodiments, a sensor device may provide multiple functions. For example, a robot 106 and/or a drone 110 may be used to capture aspects of the landscape environment including but not limited to capturing imagery of the landscape, plants and/or other objects; collecting and/or analyzing soil samples; collecting and/or analyzing plant samples; taking temperature and humidity measurements; evaluating sun and/or shade conditions; and the like. In embodiments, some sensors, for example a robot 106 and/or a drone 110, may be mobile and may move around in the landscape or outside of the landscape to collect data and/or images. In embodiments, sensors on a robot 106 or a drone 110 may reduce the number of fixed sensors 108 needed in the landscape ground.

In embodiments, the landscape may also include emitter devices 112 that may be used to apply water and/or chemicals, for example fertilizer, to areas of the landscape. In embodiments, emitter devices 112 may be in fixed areas within the landscape and may be movable among different areas within the landscape. In embodiments, the emitter devices may have water and/or chemicals delivered to them from a remote source, or may be stored at the location of the emitter device 112. In embodiments, other devices, such as a robot 106 or a drone 110, may also be used in the function of an emitter device 112, for example by delivering water, chemicals, or other material to one or more locations in the landscape, or to one or more plants in the landscape. For example a robot 106 or a drone 110 may fill its reservoir with water or other items, such as fertilizers, pesticides, insecticides, and deliver the reservoir contents in a controlled and precise way to one or more plants, as well as monitor the future effect on the plant.

In embodiments, a landscape manager (LM) apparatus 114 may be used to communicate with sensor devices 104, 106, 108, 110 and with emitters 112, and with devices that may serve as emitters such as a robot 106 and a drone 110. The LM apparatus 114 may store and/or retrieve information from a landscape preferences database 116, and a landscape model database 120. The LM database 116 may use the information in database 116, and landscape model database 120 to monitor and control sensor devices 104, 106, 108, 110 and emitters 112. In embodiments, the LM apparatus 114 may also retrieve information from external data bases 118, and additionally use the information to monitor and control sensor devices 104, 106, 108, 110 and emitters 112.

In embodiments, the landscape preference database 116 may include desired trade-offs for one or more plants 102a-102e given a limited amount of water, chemicals, or other material to be distributed among the plants of the landscape. For example, given a choice, one owner or property manager may wish to have a robust tomato crop from tomato plants 102e at the expense of dryer or brownish grass 102d. Another owner or property manager may choose to have more vibrant rosebushes 102b and greener grass 102d, but may be willing to tolerate a poorer crop from tomato plants 102e. In this way, the landscape preferences database 116 may capture an owner and/or property manager's individual landscape utility function: an individual trade-off preference in plant conditions for the property that may be different than another owner/property manager's tradeoff preference for a different property.

In embodiments, the landscape preferences database may be initially configured by a series of questions posed to the property owner and/or property manager. For example, the LM apparatus 114 may cause a series of images each showing a different landscape showing plants in varying degrees of water stress to presented to a property manager, who may then rate a preference for each of these landscapes. This way, the LM apparatus 114 may begin to learn about how tolerant the property manager is to lowering water usage. In embodiments, this process may be repeated after the landscape preferences database 116 is initially configured, to provide for changes in the property manager's preferences over time. In embodiments, the property manager may provide feedback to the LM apparatus 114 by identifying the plants and/or other vegetation that may look unhealthy to an unacceptable extent. This information may then be processed and stored in the landscape preferences database 116. In embodiments, this approach may make it easier for a property manager to articulate preferences for the desired landscape look, plant harvest goals, and water savings.

In embodiments, the landscape model database 120 may contain information about the landscape that may be in the form of images, data, neural-network data or other learning systems data. The database may include information related to, but not limited to, the type of plants located at various locations throughout the landscape. It may include imaging data, and landscape properties such as slopes, blocking structures, shade percentages, visits from animals both wild and domesticated. It may also include soil conditions such as types of soil, disease in the soil, and moisture level in various locations throughout the landscape.

In embodiments, the LM apparatus 114 may use environmental and/or other data from external data sources 118. In embodiments, external data sources 118 may include data feeds, searches, or reports in audio, video, text, imaging, graphics, or other data formats. External data may include temperature, humidity, precipitation, and cloud cover for the surroundings of the landscape. Forecasting data may also be included that may influence changes in watering schedules. In embodiments, this data may include aerial imagery of the local environment and satellite data such as images captured by and provided by NASA.

The data in external data sources 118 may also include other sources such as watershed status, information about the neighborhood the property is in, such as covenants and/or regulations associated with the neighborhood, municipal policies, and the like. Other external data may include special events of the property, such as an upcoming outdoor party, or a showing for sale.

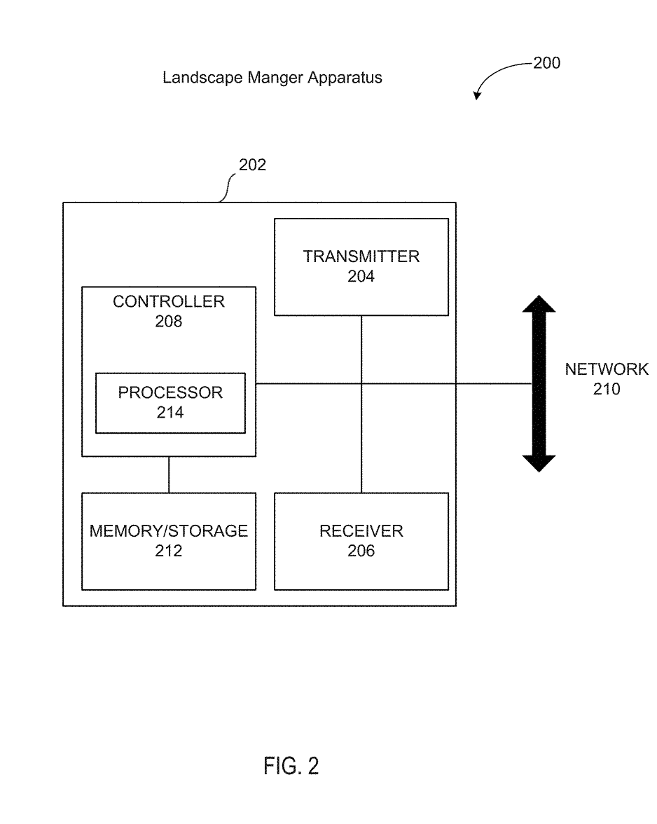

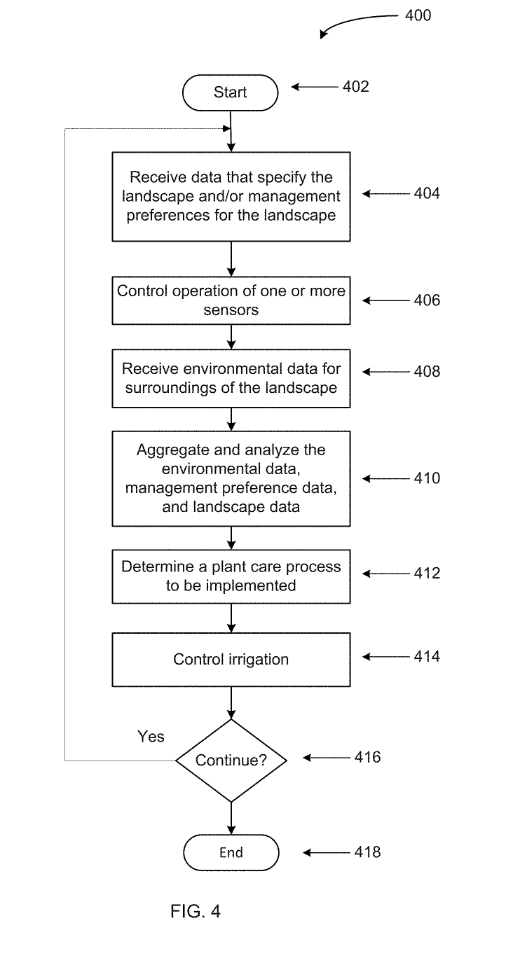

FIG. 2 illustrates using diagram 200 a LM apparatus 202, which may be similar to the LM apparatus 114, in accordance with various embodiments. In embodiments, the LM apparatus 202 may be incorporated into or otherwise be a part of a user equipment (UE) device such as a smartphone, a computer tablet, a laptop computer, a desktop computer, a set-top box, a game console, a server, or some other type of electronic device. In embodiments, the LM apparatus 202 may include radio transmitter 204 and receiver 206 coupled to controller 208. In embodiments, the transmitter 204 and/or receiver 206 may be elements or modules of a transceiver (not shown). The LM apparatus 202 may be coupled with one or more plurality of antenna elements of one or more antennas (not shown) to communicatively connect with network 210. The LM apparatus 202 or more specifically, its components may be configured to perform operations similar to those later described with references to FIG. 4.

The controller 208 may be configured to receive data that specify landscape or management preferences for the landscape, to control operation of one or more sensors to record and report landscape associated operational data, receive environmental data for surroundings of the landscape, aggregate and analyze the environmental data, the management preference data, and the landscape data and to control and irrigation system and/or chemical delivery system for the landscape based at least in part on a result of the analysis. The controller 208 may include a processor 214 to execute, for example, instructions that are stored upon the memory/storage 212 to perform the operations later described. The controller 208 may be configured to (e.g., in response to execution of the instructions) aggregate and analyze environmental data, management preference data, and landscape data. The transmitter 204 and/or receiver 208 may be configured to send and/or receive one or more signals or transmissions in accordance with requesting information related to the landscape, causing scanning of the landscape, and/or causing irrigation and/or chemical delivery to the landscape.

Each of transmitter 204, receiver 206 and controller 208 may be constituted with various circuitry. As used herein, the term “circuitry” may refer to, be part of, or include an Application Specific Integrated Circuit (ASIC), or a programmable circuit (such as field programmable gate arrays). In alternate embodiments, as earlier described for controller 208, any circuitry may be implemented with a processor (shared, dedicated, or group), and memory (shared, dedicated, or group) having one or more software or firmware programs, to provide the described functionality.

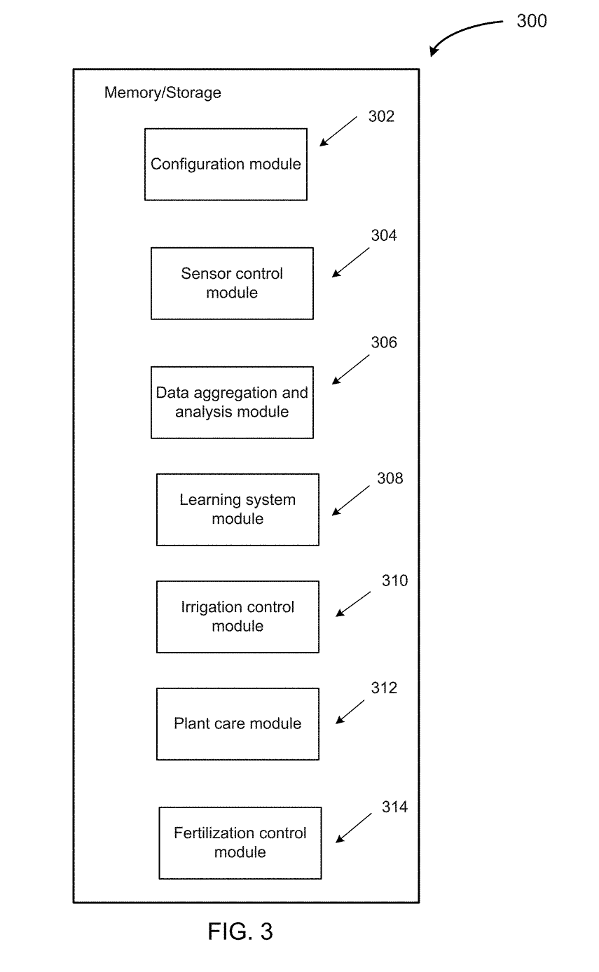

As described earlier, memory/storage 212 of controller 208 may be used to load and store data and/or instructions. Memory/storage 212, in one embodiment, may include any combination of suitable volatile memory (e.g., dynamic random access memory (DRAM)) and/or non-volatile memory (e.g., Flash memory). Memory/storage 212 is described further in FIG. 3 below.

Embodiments of the technology employed by transmitter 204 and received 206 may be related to the 3GPP long term evolution (LTE) or LTE-advanced (LTE-A) standards. However, in other embodiments the technology may be used in or related to other wireless technologies such as the Institute of Electrical and Electronic Engineers (IEEE) 802.16 wireless technology (WiMax), IEEE 802.11 wireless technology (WiFi), various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed.

FIG. 3 illustrates example modules that may reside on a memory that may be associated with LM apparatus circuitry, a part of LM apparatus circuitry, or some other type of circuitry, in accordance with various embodiments. The term “modules” as used herein (and in the claims) refers to “software modules” having instructions (which may be compiled or in source form to be interpreted or compiled). The memory/storage 312 may be similar to the memory/storage 212 of FIG. 2. It may be recognized that, while the modules depicted in memory/storage 312 are arranged in a particular order and illustrated once each, in various embodiments, one or more of the modules may be repeated, omitted or executed out of order. In other embodiments, some modules may be combined or split.

The configuration module 302, when executed, may receive data that specifies the landscape or management preferences for the landscape. This data may be received from an owner and/or property manager of the landscape either initially, when the LM apparatus 202 is set up and the landscape preferences database 116 is initially populated. This data may also be received from an owner and/or property manager during the landscape management process by, in one non-limiting example, providing positive and/or negative feedback on the appearance and health of plants in the landscape. This data may be stored and/or updated in the landscape preferences database 116.

The sensor control module 304, when executed, may control various landscape sensor devices, which may include cameras 104, in-ground sensors 108, and/or mobile sensors such as sensors attached to a robot 106 or to a drone 110. In non-limiting examples, the sensor control module 304 may send commands to individual sensors to cause the sensors to change position, to identify a specific landscape feature to be sensed, or to cause the sensor to begin to collect data for transfer back to the LM apparatus 202.

The data aggregation and analysis module 306, when executed, may receive data from sensors controlled by the sensor control module 304, receive data from the local landscape model 120, and/or receive data from external data sources 118. In addition, the module may analyze, for example to associate, correlate, compare, extrapolate, the data received and aggregated.

The learning system module 308, when executed, may take the data received and/or the data aggregated by the data aggregation and analysis module 306, which may include images and/or data, and put the aggregated data into a learning algorithm such as an artificial neural network or other artificial intelligence-based learning system. The operation of this module may be described in more detail in block 410.

The irrigation control module 310, when executed, may cause water, to be deposited in various locations in the landscape. In embodiments, the water may be distributed by emitters 112, which may be fixed in location, by a robot 106 or by a drone 110 which may cover multiple locations. In embodiments, the irrigation control module 310 may issue written instructions that may be executed by a human.

The plant care module 312, when executed, may determine the plant care process to be implemented. This process may be based on the data in the landscape preferences database 116, data from the local landscape model 120 and/or data from external data sources 118. In embodiments, the plant care module 312 may present a property landscape profile and one or more indications of the plant care process for review. This review may be done electronically, or by a human. In embodiments, if there are any changes to the plant care process, these changes may be reflected in the landscape preferences database 116 and/or the local landscape model 120.

The fertilization control module 314, when executed, may cause fertilizer or other chemicals to be deposited in various locations in the landscape. In embodiments, the fertilizer or other chemicals may be distributed by emitters 112, which may be fixed in location, and/or by a robot 106 or by a drone 110 which may cover multiple locations. In embodiments, the fertilization control module 310 may issue written instructions that may be executed by a human.

FIG. 4 is a flow diagram of an illustrative process 400 for landscape management by a LM apparatus, in accordance with various embodiments. It may be recognized that, while the operations of the process 400 are arranged in a particular order and illustrated once each, in various embodiments, one or more of the operations may be repeated, omitted or performed out of order. In alternate embodiments, some operations may be combined or split. For illustrative purposes, operations of the process 400 may be described as performed by the landscape manager apparatus 114 of FIG. 1, but the operations of the process 400, including individual operations of the process 400, may be performed by any suitably configured computing device or collection of computing devices.

The process 400 may start at block 402.

At block 404, data that specify the landscape and/or management preferences for the landscape may be received. In embodiments, the data may be received e.g., by the configuration module 302 and/or the data aggregation and analysis module 306. As described earlier, these data may include data indicating either initial or updated landscape or management preferences , from a property manager or owner. The data may be stored in the landscape preferences database 116 and/or landscape model database 120. The data may be generated as a result of feedback provided by a property manager/owner after review of a report on landscape status provided by plant care module 312. For example, the owner and/or property manager may view the images and other information of the most recent state of plants on the landscape, and indicate which plants look healthy and which plants look unhealthy. The resulting data may be further analyzed and/or updated in the landscape preferences database 116.

At block 406, operation of one or more sensors may be controlled. In embodiments, the control operation may be performed by the sensor control module 304. In embodiments, the control operations may include controlling a drone 110, a robot 106, or a land-based camera 104 to capture various landscape images. For example, a drone 110 may be signaled to fly to one or more specific locations within the landscape, and may capture imagery of the landscape, at varying resolutions, including images of plants at various angles. In embodiments, the images may be outside of the visible spectrum, such as infrared or ultraviolet images. To be effective, drones may not always fly at high altitudes, and may hover close to the landscape. In embodiments, the resulting imagery may be used to monitor the health of the landscape and detect any changes that may need to be addressed. The imaging data may be used to monitor plant bloom time, animal presence, bird migration patterns and other important milestones related to the landscape.

In embodiments, the control operations may include landscape sensing. For example, ground-based sensors 108, sensors on a robot 106, sensors on a drone 110, or other sensor mechanisms, may be controlled to perform a number of sensing operations, and report the results of the sensing. These sensors may sense and report soil, chemical, and moisture data of various locations in the landscape to evaluate the health of landscape and detect changes that may need to be addressed. Sensors may also be employed to identify wildlife, domestic pets, insects, and other fauna interacting with the plants and/or landscape that may need to be addressed.

At block 408, environmental data for surroundings of the landscape may be received. In embodiments, this may be performed by the data aggregation and analysis module 306. The acquired data may include data that was generated from the previous block, data that may be received from the property owner and/or the property manager that indicates conditions on the property, data received from the local landscape model 120, and data received from external data sources 118. In embodiments, the external data sources 118 may include, but are not limited to, forecasting data, satellite data, such as data provided by NASA, watershed status, historical environmental data, current temperature data, humidity data, precipitation, and/or cloud cover data.

At block 410, aggregation and/or analysis of the environmental data, management preference data, and landscape data may be performed. In embodiments, this may be performed by the data aggregation and analysis module 306. In embodiments, the acquired data including imaging data, landscape properties, soil conditions, and the like, may be analyzed by an artificial intelligence (AI)-based learning system, which may be operated by the LM apparatus 114. The Al system may be configured, for example, to identify and classify images based on their properties, and classify plants that may be under stress, for example by being under watered or overcrowded, and healthy or acceptable plants based at least upon data in the landscape preferences database 116.

In embodiments, the AI system may include an image sensing function that may learn to infer landscape conditions given aerial images by using convolutional neural networks (CNNs). There may be several advantages of using CNNs. CNNs may learn from the multiple resolutions captured by a drone flying at different altitudes. This is because CNNs may learn visual features with different levels of complexity, including pixels, borders, segments, textures. In addition, CNNs may take advantage of two-dimensional representations of images by constraining neighboring neurons to learn similar spatial data. Finally, CNNs may provide useful classification metrics when a large number of landscape and/or plant classes are expected, which may frequently materialize in the presence of multiple dynamic variables when capturing images of landscapes and gardens at different times that may include the presence of clouds, dynamic illumination, unknown objects on properties, and the like.

In embodiments, the AI system may be used to populate and update a big data database of plant health and plant reaction to multiple conditions. In embodiments, this big data database may be distributed worldwide and may include millions of plants and millions of different landscape and environmental conditions that may be used to indicate the success or the lack thereof of a plant in any sort of environmental condition. One of the inputs may include data in the local landscape model 120 that may indicate the property owner and/or property manager experiences with differing plant outcomes given differing amounts of water, fertilizer, soil composition, and the like applied to various plants and portions of the landscape over time.

At block 412, a plant care process to be implemented, may be determined. In embodiments, this may be performed by the plant care module 312, the irrigation module 310, and/or the fertilization control module 314. In embodiments, the results of the data analysis from the previous block may be used to implement irrigation, fertilization, and/or other plant care actions by sending instructions to one or more devices in the landscape (and/or workers).

In a non-limiting example, accumulated history of local conditions, humidity and weather forecast, pests, and other data processed by the AI network, may determine and optimal time of day to turn the sprinklers on in order to achieve the property owner and/or property manager preferences for the landscape.

In addition, the process may propose, to a property manager, landscape ideas that match landscape preferences. For example, instead of using succulent plants such as foxglove to cut down on water use, the system may recommend planting lupines.

In embodiments, the plant care process may include an instruction list given to the property owner and/or the property manager with tasks to perform around the landscape.

In embodiments, determination of the plant care process may take into account feedback from the property manager. For example, a drone may take images of the landscape that may be used to identify areas on the landscape and show plans for water distribution with the color red overlaid on areas to be watered less frequently and the color blue overlaid on areas to be watered more frequently. Based at least on this information, the property manager may choose to alter landscape preferences that may be stored in the landscape preferences database 118. For example, the color blue may be overlaid on images of landscape areas that include blueberry bushes that are not receiving at least a threshold amount of water to produce berries. The color red may be overlaid on images of landscape areas that include established maple or grape vine that may be watered less and still remain green.

At block 414, irrigation may be controlled. In embodiments, this may be performed by the irrigation control module 310, plant care module 312, and/or fertilization control module 314. In embodiments, to control irrigation may include to control existing watering infrastructure, such as sprinklers, with a Wi-Fi or other wireless enabled controller. If no automated watering systems are present, then a property owner and/or property manager may be presented with a schedule for manual watering, or changes in an existing watering schedule. In embodiments, a watering regimen may be implemented by a drone 110 or by a robot 106.

At block 416, a determination may be made to continue and repeat the process. If so, the process may revert back to block 404. Otherwise, the process may end at block 416.

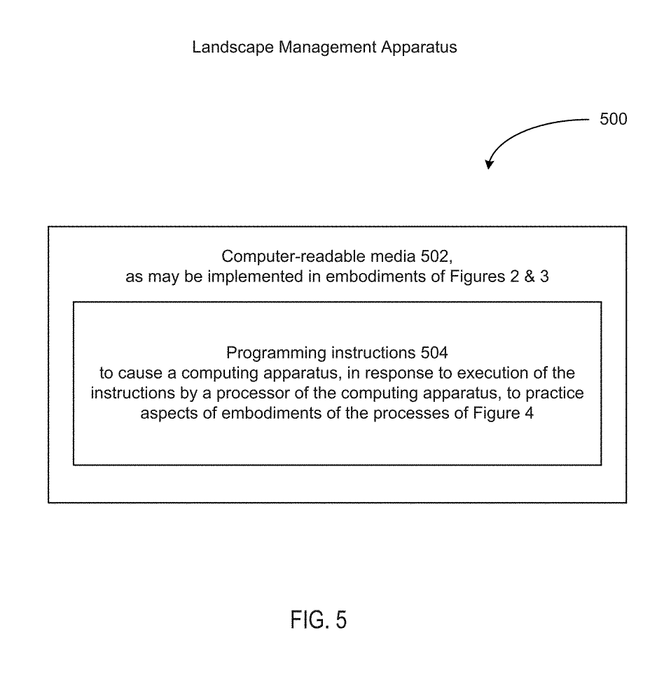

FIG. 5 is a diagram 500 illustrating a computer readable media 502 having instructions for practicing the earlier described methods, or programmable/causing systems and devices to perform the above-described techniques, in accordance with various embodiments . In some embodiments, such computer readable media 502 may be either transitory or non-transitory, and may be included in a memory or storage device of the LM apparatus 114 in FIG. 1, or memory/storage 212 of FIG. 2. In embodiments, instructions 504 may include assembler instructions supported by a processing device, or may include instructions in a high-level language, such as C, that can be compiled into object code executable by the processing device. In some embodiments, a persistent copy of the computer readable instructions 504 may be placed into a persistent storage device in the factory or in the field (through, for example, a machine-accessible distribution medium (not shown), such as a compact disc). In some embodiments, a persistent copy of the computer readable instructions 504 may be placed into a persistent storage device through a suitable communication pathway (e.g., from a distribution server).

The following paragraphs provide a number of examples of embodiments of the present disclosure.

### EXAMPLES

Example 1 is an apparatus for managing a landscape of a property, comprising: one or more processors; a configuration module, to be executed by the one or more processors, to receive data that specify the landscape or management preferences for the landscape; a sensor control module, to be executed by the one or more processors, to control operation of one or more sensors that record and report landscape associated operational data; a data aggregation and analysis module, to be executed by the one or more processors, to: receive environmental data for surroundings of the landscape; and aggregate and analyze the environmental data, the management preference data, and the landscape data; and an irrigation control module, to be executed by the one or more processors, to control an irrigation system to provide irrigation for the landscape, based at least in part on a result of the analysis.

Example 2 may include the subject matter of Example 1, further comprising: a plant care module, to be executed by the one or more processors, to determine a plant care process to be implemented, based at least in part on a result of the analysis.

Example 3 may include the subject matter of Examples 1-2, wherein the plant care module is further to present a property landscape profile and one or more indications of the plant care process for review.

Example 4 may include the subject matter of Example 1, wherein the landscape specification data includes identifications of a plurality of plants of the landscape and locations of the plurality of plants; and wherein management preferences include respective desired conditions of the plurality of plants.

Example 5 may include the subject matter of Example 4, wherein the respective desired conditions of the plurality of plants are determined from the contents of a learning system that is based at least in part on a human evaluation of the landscape or of one or more landscape images.

Example 6 may include the subject matter of Examples 1 and 4, wherein the landscape associated operational data include soil composition data, soil wetness data, soil disease indications, or soil temperature data.

Example 7 may include the subject matter of Example 1, wherein the one or more sensors include an image sensor; and wherein the sensor control module is to control the image sensor to record and report images of a plurality of plants of the landscape.

Example 8 may include the subject matter of Examples 1 or 7, wherein the one or more sensors include one or more in-ground sensors, robotic sensors, fixed-location cameras, cameras on a drone, sensors on a drone, cameras on an overhead plane, or satellites.

Example 9 may include the subject matter of Example 1, wherein to receive environmental data, the data aggregation and analysis module is to receive environmental data from local, regional, national, or international weather monitoring sites that provide temperature, humidity, precipitation, cloud cover, weather forecasting, satellite imagery, watershed status, and upcoming weather events associated with the surroundings of the landscape.

Example 10 may include the subject matter of Example 1, wherein to analyze the aggregated data, the data aggregation and analysis module is to: receive a plurality of images of the landscape; and perform an inference of landscape conditions using convolutional neural networks.

Example 11 may include the subject matter of Examples 1 or 10, wherein to analyze the aggregated data, the data aggregation and analysis module is further to: provide the aggregated data to a learning system of plant health and plant reactions to multiple conditions.

Example 12 may include the subject matter of Example 11, wherein the data aggregation and analysis module is further to determine a plant care process to be implemented, using at least the learning system and the management preferences, wherein the plant care process includes times, amounts, or locations of water or chemicals to be applied to a plurality of plants in the landscape.

Example 13 may include the subject matter of Example 12, wherein the data aggregation and analysis module is further to output a description of the plant care process for implementation by a human.

Example 14 may include the subject matter of Example 13, wherein the data aggregation and analysis module is further to output recommendations for planting plants in areas of the landscape, based at least in part on the management preferences.

Example 15 may include the subject matter of Example 11, wherein the data aggregation and analysis module is further to receive, from data sources external to the apparatus, learning system data for a second landscape.

Example 16 may include the subject matter of Example 15, wherein the second landscape is selected based at least on one or more similar preference items between the management preferences and management preferences associated with the second landscape.

Example 17 may include the subject matter of Example 11, wherein the data aggregation and analysis module is further to identify the response of a plant having a watering regimen in the landscape based at least on landscape data of an area of the landscape in proximity to the plant.

Example 18 may include the subject matter of Example 1, wherein the irrigation system includes a robot, a drone, or a ground-based emitter, and wherein to control the irrigation system the irrigation control module is to provide irrigation instructions to the robot, the drone or the ground-based emitter.

Example 19 include the subject matter of Example 18, wherein to provide irrigation instructions further includes to provide irrigation instructions for automatic application by the robot or by the drone.

Example 20 may include the subject matter of Example 1, further comprising a fertilization control module to be operated by the one or more processors to control a fertilization system to provide fertilization to the landscape.

Example 21 may include the subject matter of Example 20, wherein the fertilization system includes a robot, a drone, or a ground-based emitter; and wherein to control the fertilization system the fertilization control module is to provide fertilization instructions to the robot, the drone or the ground-based emitter.

Example 22 may include the subject matter of Example 21, wherein to provide fertilization instructions further includes to provide fertilization instructions to automatically apply fertilizer by the robot or by the drone.

Example 23 is a method for managing a landscape of a property, comprising: receiving, by a computing device, data that specify the landscape or management preferences for the landscape; controlling, by the computing device, operation of one or more sensors that record and report landscape associated operational data; receiving, by the computing device, environmental data for surroundings of the landscape; aggregating and analyzing, by the computing device, the environmental data, the management preference data, and the landscape data; and controlling, by the computing device, an irrigation system to provide irrigation for the landscape, based at least in part on a result of the analyzing.

Example 24 may include the subject matter of Example 23, further comprising determining, by the computing device, a plant care process to be implemented, based at least in part on a result of the analysis.

Example 25 may include the subject matter of Example 24, further comprising presenting, by the computing device, a property landscape profile and one or more indications of the plant care process for review.

Example 26 may include the subject matter of Example 23, wherein the landscape specification data includes identifications of a plurality of plants of the landscape and locations of the plurality of plants; and wherein management preferences include respective desired conditions of the plurality of plants.

Example 27 may include the subject matter of Example 26, wherein the respective desired conditions of the plurality of plants are determined from the contents of a learning system that is based at least in part on a human evaluation of the landscape or of one or more landscape images.

Example 28 may include the subject matter of Example 23, wherein the landscape associated operational data include soil composition data, soil wetness data, soil disease indications, or soil temperature data.

Example 29 may include the subject matter of Example 23, wherein the one or more sensors include an image sensor.

Example 30 may include the subject matter of Example 29, further comprising controlling, by the computing device, the image sensor to record and report images of a plurality of plants of the landscape.

Example 31 may include the subject matter of Example 23, wherein the one or more sensors include one or more in-ground sensors, robotic sensors, fixed-location cameras, cameras on a drone, sensors on a drone, cameras on an overhead plane, or satellites.

Example 32 may include the subject matter of Example 23, wherein receiving, by the computing device, environmental data is to further include receiving, by the computing device, environmental data from local, regional, national, or international weather monitoring sites that provide temperature, humidity, precipitation, cloud cover, weather forecasting, satellite imagery, watershed status, and upcoming weather events associated with the surroundings of the landscape.

Example 33 may include the subject matter of Example 23, wherein analyzing, by the computing device, the aggregated data further includes: receiving, by the computing device, a plurality of images of the landscape; and performing, by the computing device, an inference of landscape conditions using convolutional neural networks.

Example 34 may include the subject matter of Example 33, wherein analyzing, by the computing device, the aggregated data further includes providing, by the computing device, the aggregated data to a learning system of plant health and plant reactions to multiple conditions.

Example 35 may include the subject matter of Example 34, further comprising: determining, by the computing device, a plant care process to be implemented, using at least the learning system and the management preferences, wherein the plant care process includes times, amounts, or locations of water or chemicals to be applied to a plurality of plants in the landscape.

Example 36 may include the subject matter of Example 35, further comprising outputting, by the computing device, a description of the plant care process for implementation by a human.

Example 37 may include the subject matter of Example 36, further comprising outputting, by the computing device, recommendations for planting plants in areas of the landscape, based at least in part on the management preferences.

Example 38 may include the subject matter of Example 34, further comprising receiving, by the computing device, from data sources external to the apparatus, learning system data for a second landscape.

Example 39 may include the subject matter of Example 38, wherein the second landscape is selected based at least on one or more similar preference items between the management preferences and management preferences associated with the second landscape.

Example 40 may include the subject matter of Example 34, further comprising identifying, by the computing device, the response of a plant having a watering regimen in the landscape based at least on landscape data of an area of the landscape in proximity to the plant.

Example 41 may include the subject matter of Example 23, wherein the irrigation system includes a robot, a drone, or a ground-based emitter, and wherein controlling, by the computing device, the irrigation system further comprises providing, by the computing device, irrigation instructions to the robot, the drone or the ground-based emitter.

Example 42 may include the subject matter of Example 41, wherein providing, by the computing device, irrigation instructions further includes providing, by the computing device, irrigation instructions for automatically applying irrigation by the robot or by the drone.

Example 43 may include the subject matter of Example 23, further comprising controlling, by the computing device, a fertilization system to provide fertilization to the landscape.

Example 44 may include the subject matter of Example 43, wherein the fertilization system includes a robot, a drone or a ground-based emitter; and wherein controlling, by the computing device, the fertilization system further includes providing, by the computing device, fertilization instructions to the robot, the drone or the ground-based emitter.

Example 45 may include the subject matter of Example 44, wherein controlling, by the computing device, a fertilization system further includes providing, by the computing device, irrigation system robot will fertilization instructions for automatically applying fertilizer by the robot or by the drone.

Example 46 is an apparatus for managing a landscape of a property, the apparatus comprising: means for receiving data that specify the landscape or management preferences for the landscape; means for controlling operation of one or more sensors that record and report landscape associated operational data; means for receiving environmental data for surroundings of the landscape; means for aggregating and analyzing the environmental data, the management preference data, and the landscape data; and means for controlling an irrigation system to provide irrigation for the landscape, based at least in part on a result of the analyzing.

Example 47 may include the subject matter of Example 46, further comprising means for determining a plant care process to be implemented, based at least in part on a result of the analysis.

Example 48 may include the subject matter of Example 47, further comprising means for presenting a property landscape profile and one or more indications of the plant care process for review.

Example 49 may include the subject matter of Example 46, wherein the landscape specification data includes identifications of a plurality of plants of the landscape and locations of the plurality of plants; and wherein management preferences include respective desired conditions of the plurality of plants.

Example 50 may include the subject matter of Example 49, wherein the respective desired conditions of the plurality of plants are determined from the contents of a learning system that is based at least in part on a human evaluation of the landscape or of one or more landscape images.

Example 51 may include the subject matter of Example 46, wherein the landscape associated operational data include soil composition data, soil wetness data, soil disease indications, or soil temperature data.

Example 52 may include the subject matter of Example 46, wherein the one or more sensors include an image sensor.

Example 53 may include the subject matter of Example 52, further comprising means for controlling the image sensor to record and report images of a plurality of plants of the landscape.

Example 54 may include the subject matter of Example 46, wherein the one or more sensors include one or more in-ground sensors, robotic sensors, fixed-location cameras, cameras on a drone, sensors on a drone, cameras on an overhead plane, or satellites.

Example 55 may include the subject matter of Example 46, wherein means for receiving environmental data is to further include means for receiving environmental data from local, regional, national, or international weather monitoring sites that provide temperature, humidity, precipitation, cloud cover, weather forecasting, satellite imagery, watershed status, and upcoming weather events associated with the surroundings of the landscape.

Example 56 may include the subject matter of Example 46, wherein means for analyzing the aggregated data further includes: means for receiving a plurality of images of the landscape; and means for performing an inference of landscape conditions using convolutional neural networks.

Example 57 may include the subject matter of Example 56, wherein means for analyzing the aggregated data further includes means for providing the aggregated data to a learning system of plant health and plant reactions to multiple conditions.

Example 58 may include the subject matter of Example 57, further comprising: means for determining a plant care process to be implemented, using at least the learning system and the management preferences, wherein the plant care process includes times, amounts, or locations of water or chemicals to be applied to a plurality of plants in the landscape.

Example 59 May include the subject matter of Example 58, further comprising means for outputting a description of the plant care process for implementation by a human.

Example 60 may include the subject matter of Example 59, further comprising means for outputting recommendations for planting plants in areas of the landscape, based at least in part on the management preferences.

Example 61 may include the subject matter of Example 57, further comprising means for receiving from data sources external to the apparatus, learning system data for a second landscape.

Example 62 may include the subject matter of Example 61, wherein the second landscape is selected based at least on one or more similar preference items between the management preferences and management preferences associated with the second landscape.

Example 63 may include the subject matter of Example 56, further comprising means for identifying the response of a plant having a watering regimen in the landscape based at least on landscape data of an area of the landscape in proximity to the plant.

Example 64 may include the subject matter of Example 46, wherein the irrigation system includes a robot, a drone, or a ground-based emitter, and wherein means for controlling the irrigation system further comprises means for providing irrigation instructions to the robot, the drone or the ground-based emitter.

Example 65 may include the subject matter of Example 64, wherein means for providing irrigation instructions further includes means for providing irrigation instructions for automatically applying irrigation by the robot or by the drone.

Example 66 may include the subject matter of Example 46, further comprising means for controlling a fertilization system to provide fertilization to the landscape.

Example 67 may include the subject matter of Example 66, wherein the fertilization system includes a robot, a drone or a ground-based emitter; and wherein means for controlling the fertilization system further includes means for providing fertilization instructions to the robot, the drone or the ground-based emitter. [000139] Example 68 may include the subject matter of Example 66, wherein means for controlling a fertilization system further includes means for providing fertilization instructions for automatically applying fertilizer by the robot or by the drone.

Example 69 is one or more non-transitory computer-readable media comprising instructions that cause a computing device, in response to execution of the instructions by the computing device, to: receive data that specify the landscape or management preferences for the landscape; control operation of one or more sensors that record and report landscape associated operational data; receive environmental data for surroundings of the landscape; aggregate and analyze the environmental data, the management preference data, and the landscape data; and control, by the computing device, an irrigation system to provide irrigation for the landscape, based at least in part on a result of the analysis.

Example 70 may include the subject matter of Example 69, further comprising determine a plant care process to be implemented, based at least in part on a result of the analysis.

Example 71 may include the subject matter of Example 69, further comprising to present a property landscape profile and one or more indications of the plant care process for review.

Example 72 may include the subject matter of Example 69, wherein the landscape specification data includes identifications of a plurality of plants of the landscape and locations of the plurality of plants; and wherein management preferences include respective desired conditions of the plurality of plants.

Example 73 may include the subject matter of Example 72, wherein the respective desired conditions of the plurality of plants are determined from the contents of a learning system that is based at least in part on a human evaluation of the landscape or of one or more landscape images.

Example 74 may include the subject matter of Example 69, wherein the landscape associated operational data include soil composition data, soil wetness data, soil disease indications, or soil temperature data.

Example 75 may include the subject matter of Example 69, wherein the one or more sensors include an image sensor.

Example 76 may include the subject matter of Example 72, further comprising to control the image sensor to record and report images of a plurality of plants of the landscape.

Example 77 may include the subject matter of Example 69, wherein the one or more sensors include one or more in-ground sensors, robotic sensors, fixed-location cameras, cameras on a drone, sensors on a drone, cameras on an overhead plane, or satellites.

Example 78 may include the subject matter of Example 69, wherein to receive environmental data is to further include to receive environmental data from local, regional, national, or international weather monitoring sites that provide temperature, humidity, precipitation, cloud cover, weather forecasting, satellite imagery, watershed status, and upcoming weather events associated with the surroundings of the landscape.

Example 79 may include the subject matter of Example 69, wherein to analyze the aggregated data further includes: to receive a plurality of images of the landscape; and to perform an inference of landscape conditions using convolutional neural networks.

Example 80 may include the subject matter of Example 79, wherein to analyze the aggregated data further includes to provide the aggregated data to a learning system of plant health and plant reactions to multiple conditions.

Example 81 may include the subject matter of Example 80, further comprising: to determine a plant care process to be implemented, using at least the learning system and the management preferences, wherein the plant care process includes times, amounts, or locations of water or chemicals to be applied to a plurality of plants in the landscape.

Example 82 may include the subject matter of Example 81, further comprising to output a description of the plant care process for implementation by a human.

Example 83 may include the subject matter of Example 82, further comprising to output recommendations for planting plants in areas of the landscape, based at least in part on the management preferences.

Example 84 may include the subject matter of Example 80, further comprising to receive from data sources external to the apparatus, learning system data for a second landscape.

Example 85 may include the subject matter of Example 84, wherein the second landscape is selected based at least on one or more similar preference items between the management preferences and management preferences associated with the second landscape.

Example 86 may include the subject matter of Example 80, further comprising to identify the response of a plant having a watering regimen in the landscape based at least on landscape data of an area of the landscape in proximity to the plant.

Example 87 may include the subject matter of Example 69, wherein the irrigation system includes a robot, a drone, or a ground-based emitter, and wherein to control the irrigation system further comprises to provide irrigation instructions to the robot, the drone or the ground-based emitter.

Example 88 may include the subject matter of Example 87, wherein to provide irrigation instructions further includes to provide irrigation instructions for automatically applying irrigation by the robot or by the drone.

Example 89 may include the subject matter of Example 69, further comprising to control a fertilization system to provide fertilization to the landscape.

Example 90 may include the subject matter of Example 89, wherein the fertilization system includes a robot, a drone or a ground-based emitter; and wherein to control the fertilization system further includes to provide fertilization instructions to the robot, the drone or the ground-based emitter.

Example 91 may include the subject matter of Example 90, wherein to control a fertilization system further includes to provide fertilization instructions for automatically applying fertilizer by the robot or by the drone.

1. An apparatus for managing a landscape of a property, comprising:
one or more processors;
a configuration module, to be executed by the one or more processors, to receive data that specify the landscape or management preferences for the landscape;
a sensor control module, to be executed by the one or more processors, to control operation of one or more sensors that record and report landscape associated operational data;
a data aggregation and analysis module, to be executed by the one or more processors, to:
receive environmental data for surroundings of the landscape; and
aggregate and analyze the environmental data, the management preference data, and the landscape data; and
an irrigation control module, to be executed by the one or more processors, to control an irrigation system to provide irrigation for the landscape, based at least in part on a result of the analysis.

2. The apparatus of claim 1, further comprising:
a plant care module, to be executed by the one or more processors, to determine a plant care process to be implemented, based at least in part on a result of the analysis.

3. The apparatus of claim 2, wherein the plant care module is further to present a property landscape profile and one or more indications of the plant care process for review.

4. The apparatus of claim 1, wherein
the landscape specification data includes identifications of a plurality of plants of the landscape and locations of the plurality of plants; and
wherein management preferences include respective desired conditions of the plurality of plants.

5. The apparatus of claim 4, wherein the respective desired conditions of the plurality of plants are determined from the contents of a learning system that is based at least in part on a human evaluation of the landscape or of one or more landscape images.

6. The apparatus of claim 1, wherein the landscape associated operational data include soil composition data, soil wetness data, soil disease indications, or soil temperature data.

7. The apparatus of claim 1, wherein
the one or more sensors include an image sensor; and
wherein the sensor control module is to control the image sensor to record and report images of a plurality of plants of the landscape.

8. A method for managing a landscape of a property, comprising:
receiving, by a computing device, data that specify the landscape or management preferences for the landscape;
controlling, by the computing device, operation of one or more sensors that record and report landscape associated operational data;
receiving, by the computing device, environmental data for surroundings of the landscape;
aggregating and analyzing, by the computing device, the environmental data, the management preference data, and the landscape data; and
controlling, by the computing device, an irrigation system to provide irrigation for the landscape, based at least in part on a result of the analyzing.

9. The method of claim 8, wherein analyzing, by the computing device, the aggregated data further includes:
receiving, by the computing device, a plurality of images of the landscape; and
performing, by the computing device, an inference of landscape conditions using convolutional neural networks.

10. The method of claim 9, wherein analyzing, by the computing device, the aggregated data further includes providing, by the computing device, the aggregated data to a learning system of plant health and plant reactions to multiple conditions.

11. The method of claim 10, further comprising:
determining, by the computing device, a plant care process to be implemented, using at least the learning system and the management preferences, wherein the plant care process includes times, amounts, or locations of water or chemicals to be applied to a plurality of plants in the landscape.

12. The method of claim 11, further comprising outputting, by the computing device, a description of the plant care process for implementation by a human.

13. The method of claim 12, further comprising outputting, by the computing device, recommendations for planting plants in areas of the landscape, based at least in part on the management preferences.

14. The method of claim 10, further comprising receiving, by the computing device, from data sources external to the apparatus, learning system data for a second landscape.

15. The method of claim 14, wherein the second landscape is selected based at least on one or more similar preference items between the management preferences and management preferences associated with the second landscape.

16. One or more computer-readable media comprising instructions that cause a computing device, in response to execution of the instructions by the computing device, to:
receive data that specify the landscape or management preferences for the landscape;
control operation of one or more sensors that record and report landscape associated operational data;
receive environmental data for surroundings of the landscape;
aggregate and analyze the environmental data, the management preference data, and the landscape data; and
control, by the computing device, an irrigation system to provide irrigation for the landscape, based at least in part on a result of the analysis.

17. The computer-readable media of claim 16, wherein the one or more sensors include one or more in-ground sensors, robotic sensors, fixed-location cameras, cameras on a drone, sensors on a drone, cameras on an overhead plane, or satellites.

18. The computer-readable media of claim 16, wherein to receive environmental data is to further include to receive environmental data from local, regional, national, or international weather monitoring sites that provide temperature, humidity, precipitation, cloud cover, weather forecasting, satellite imagery, watershed status, and upcoming weather events associated with the surroundings of the landscape.

19. The computer-readable media of claim 16, wherein to analyze the aggregated data further includes:
to receive a plurality of images of the landscape; and
to perform an inference of landscape conditions using convolutional neural networks.

20. The computer-readable media of claim 19, wherein to analyze the aggregated data further includes to provide the aggregated data to a learning system of plant health and plant reactions to multiple conditions.

21. The computer-readable media of claim 20, further comprising:
to determine a plant care process to be implemented, using at least the learning system and the management preferences, wherein the plant care process includes times, amounts, or locations of water or chemicals to be applied to a plurality of plants in the landscape.

22. The computer-readable media of claim 21, further comprising to output a description of the plant care process for implementation by a human.

23. The computer-readable media of claim 22, further comprising to output recommendations for planting plants in areas of the landscape, based at least in part on the management preferences.

24. The computer-readable media of claim 20, further comprising to receive from data sources external to the apparatus, learning system data for a second landscape.

25. The computer-readable media of claim 24, wherein the second landscape is selected based at least on one or more similar preference items between the management preferences and management preferences associated with the second landscape.
